(19) United States
(12) Patent Application Publication
(10) Pub. No.: US 2012/0064420 A1
(43) Pub. Date: Mar. 15, 2012

(54) POWER GENERATION SYSTEM

(75) Inventors: Akio Machida, Kanagawa (JP); Kensuke Kojima, Kanagawa (JP); Yuichi Ishida, Kanagawa (JP)

(73) Assignee: SONY CORPORATION, Tokyo (JP)

(21) Appl. No.: 13/224,537

(22) Filed: Sep. 2, 2011

(30) Foreign Application Priority Data
Sep. 13, 2010 (JP) 2010-204377

(51) Int. Cl. H01M 8/06; F28D 15/00; B01D 53/22; F28F 7/00

(52) U.S. Cl. 429/422; 165/138; 165/104.31; 165/47; 96/4

(57) ABSTRACT

There is provided a power generation system capable of obtaining both of electrical energy and heat energy by utilizing light energy. The power generation system includes a gas generation section including one or more containers and producing gas by absorbing light energy, each of the containers enclosing an electrolytic solution and a plurality of semiconductor elements having photoelectric conversion function, a power generation section generating electrical energy by utilizing gas generated in the gas generation section; and a heat exchanger absorbing heat energy from the inside of the container.

### CROSS REFERENCES TO RELATED APPLICATIONS

The present application claims priority to Japanese Priority Patent Application JP2010-204377 filed in the Japan Patent Office on Sep. 13, 2010, the entire content of which is hereby incorporated by reference.

### BACKGROUND

The present application relates to a power generation system generating power by utilizing, for example, sunlight.

Recently, various developments to size up a silicon solar cell (solar battery) and to achieve high photoelectric conversion efficiency has been done (for example, Japanese Unexamined Patent Application publication No. Sho56-163285 and No. Sho57-13185). Most solar batteries are generally arranged on an exterior wall or a roof of a house, a building, or the like. Therefore, the solar battery to be formed is a panel type device in which crystalline materials having photoelectric conversion function are flatly spread.

However, to obtain desired electrical energy, it may be necessary to widen such panel type solar battery, and thus there is also a need to provide a wide area on which the solar battery is arranged. Further, there are needs such as arrangement of electrode wire and surface coating to give resistance to an outdoor environment, and thus power generation efficiency is sometimes affected.

In addition, a panel type solar battery fixed on a roof or the like, is difficult to sufficiently absorb sunlight varying its angle by hours or seasons. For example, as the sun altitude is lower, the light absorption efficiency reduces with the reduction of the irradiated area on the plate. Only at the solar noon (mid-term of a period from sunrise to sunset) when sunlight enters vertically into the panel on the solar battery, the light absorption efficiency of the panel type solar battery is maximum. Therefore, actually the light energy from the sun inclining throughout the day is not fully received.

### SUMMARY

Then, the above Japanese Unexamined Patent Application publication No. Sho56-163285 and No. Sho57-13185 approach an electrolysis device suspending fine solar battery elements formed by dividing a wafer into an electrolysis solution filling a container. The above electrolytic device provides the efficient absorption of sunlight with small footprint compared to a panel type solar battery. These describe that such structure allows electrolysis based on light energy, and therefore gases such as hydrogen gas are created.

Further, electrical energy is generated by supplying gases generated in the above way to a fuel cell, that is, the power generation system utilizing sunlight is achieved. Then, recently, a solar water heating system has been reviewed. The reason is that the solar water heating system has a higher energy conversion efficiency compared to a solar power. However, since it may be difficult to provide a solar photovoltaic system and a solar water heating system together on a limited footprint of a standard home, it seems that the solar power is chosen in a standard home with electricity usable. When a hybrid-type system providing, in addition to electricity supply, for example, hot-water supply at the same time is formed, the provided single device promises convenience in using electricity and the highest energy conversion efficiency with the combination of the two. In other words, a dreamlike power generation system capable of obtaining not only electrical energy but also heat energy may be achieved.

It is desirable to provide a power generation system capable of obtaining both of electrical energy and heat energy by utilizing light energy.

According to an embodiment, there is provided a power generation system including a gas generation section in which an electrolytic solution and a plurality of semiconductor elements having photoelectric conversion function are enclosed in a container, the gas generation section generating gas by absorbing light energy, a power generation section generating electrical energy by utilizing gas generated in the gas generation section, and a heat exchanger absorbing heat energy from the inside of the container.

In the power generation system according to the embodiment, as a plurality of semiconductor elements absorb the incident light inside the container, electrolysis reaction occurs in the electrolytic solution. Consequently, gas (for example, hydrogen gas) is produced in the container (light energy is converted into gas). The power generation section generates electrical energy by utilizing the produced gas in the above way. Meanwhile, although temperature increase occurs inside the container due to heat of reaction caused by the above electrolysis reaction and radiant heat from sunlight, the heat exchanger absorbs these heat energies generated inside the container.

According to the power generation system according to the embodiment, the inclusion of the electrolytic solution and the plurality of semiconductor elements having the photoelectric conversion function in the container allows the incident light into the container to be absorbed by a plurality of semiconductor elements, and therefore electrolysis reaction may occur in the electrolytic solution. Consequently, gas (for example, hydrogen gas) may be produced in the container, and the power generation section may generate electrical energy by utilizing the produced gas. Meanwhile, although temperature increase occurs inside the container due to heat of reaction caused by the above electrolysis reaction and radiant heat from sunlight, the heat exchanger may absorb these heat energies generated inside the container. Accordingly, it may be possible to obtain both of electrical energy and heat energy by utilizing light energy.

It is to be understand that both the foregoing general description and the following detailed description are exemplary and are intended to provide further explanation of the technology as claimed

Additional features and advantages are described herein, and will be apparent from the following Detailed Description and the figures.

### BRIEF DESCRIPTION OF THE FIGURES

FIG. 1 is a block diagram illustrating the entire constitution of a power generation system according to a first embodiment.

FIGS. 2A and 2B are a perspective view and a cross-sectional view respectively illustrating a schematic constitution of the gas generation section shown in FIG. 1.

FIGS. 3A and 3B are cross-sectional views respectively illustrating a detailed constitution of the container shown in FIG. 1.

FIGS. 4A to 4H are examples of the arrangement of the gas generation section shown in FIG. 1.

FIGS. 5A to 5C are examples of the arrangement of the gas generation section shown in FIG. 1.

FIG. 6 is an example of a cross-sectional structure of a pn junction device shown in FIG. 1

FIG. 7 is a diagram illustrating a cross-sectional structure of a fuel cell shown in FIG. 1.

FIG. 8 is a perspective view illustrating an installation example, in use, of the container shown in FIG. 1.

FIG. 9 is a characteristics diagram illustrating a relation between the sun location (azimuth angle elevation angle) and the solar irradiance.

FIG. 10 is a characteristics diagram illustrating a light absorption efficiency corresponding to a sun location.

FIGS. 11A and 11B are respectively diagrams illustrating: a relation between a sun azimuth angle and absorption energy; and the sunlight absorption energy and the absorption efficiency of sunlight at elevation angle of 45°.

FIG. 12 is a characteristics diagram illustrating each relation between the incidence angle of light and the absorbed light quantity at the number of times a wafer is divided.

FIGS. 13A and 13B are schematic views illustrating the structure of a gas generation section according to a modification 1, and thus FIG. 13A is a perspective view thereof and FIG. 13B is a cross-sectional view thereof.

FIGS. 14A to 14D are cross-sectional views respectively illustrating other constitutions of the container and the reflector.

FIGS. 15A to 15C are cross-sectional views respectively illustrating other constitutions of the container and the reflector.

FIGS. 16A to 16C are cross-sectional views respectively illustrating other constitutions of the container and the reflector.

FIGS. 17A and 17B are cross-sectional views respectively illustrating other constitutions of the container and the reflector.

FIGS. 18A to 18C are cross-sectional views respectively illustrating other constitutions of the container and the reflector.

### DETAILED DESCRIPTION

Embodiments of the present application will be described below in detail with reference to the drawings.

1. Embodiment (an exemplary embodiment in the case that a cooling pipe connected to a heat exchanger is arranged inside a container);

2. Modification (an exemplary embodiment in the case that a cooling pipe is arranged adjacent to the lateral face of a container (an reflector is employed); and

3. Another Modification (other shapes for a container and a reflector).

### Embodiment

### Constitution of Power Generation System 1

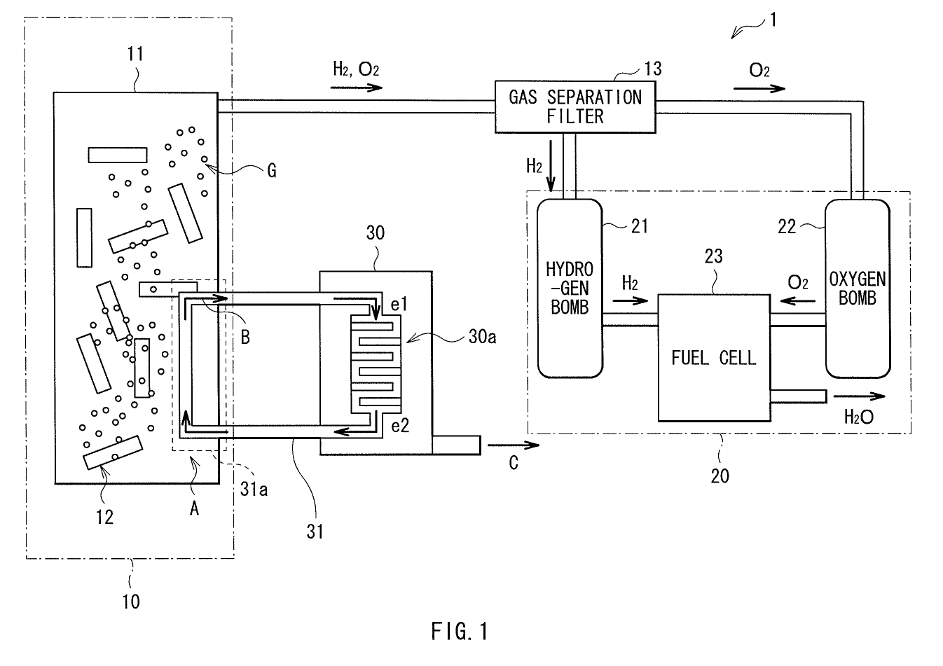

FIG. 1 shows an entire constitution of a power generation system (power generation system 1) according to an embodiment. The power generation system 1 is a solar battery system generating electrical energy by utilizing solar energy and has a gas generation section 10, a gas separation filter 13, a power generation section 20, a pipe arrangement 31, and a water heater 30 (heat exchanger).

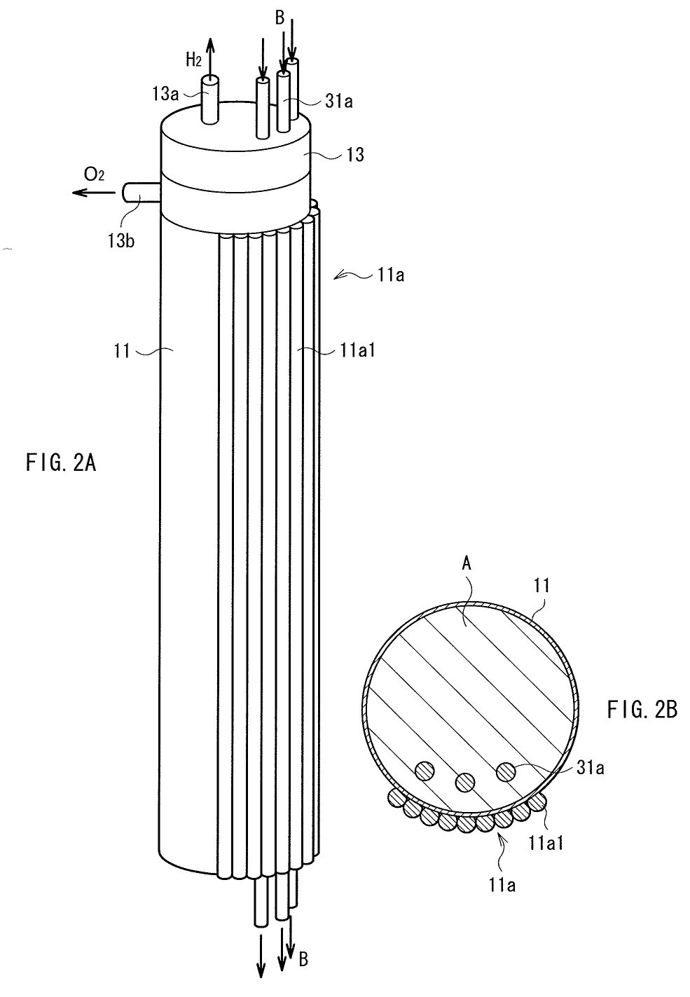

FIGS. 2A and 2B respectively show a constitution example of the gas generation section 10 and the gas separation filter 13. FIG. 2A is a perspective view and FIG. 2B is a cross-sectional view. In the gas generation section 10, a container 11 is filled with an electrolytic solution A therein, and the electrolytic solution A contains a plurality of dispersed semiconductor chips 12. The container 11 has a reflector (reflector 11a described below), arranged on a part of the lateral face of the container 11, which diffuses light entering into the container 11 to cause an increase of light absorption efficiency. The electrolytic solution A is, for example, a phosphoric acid (H₃PO₄) solution having a given concentration, and the concentration is set to a suitable value in consideration of an electric double layer. The semiconductor chip 12 is a fine solar battery element having a photoelectric conversion function. Hereinafter, the specific construction for each of sections will be described.

Container 11

The container 11 serves for containing an electrolytic solution A and a plurality of semiconductor chips 12, and further is adapted to discharge the gas generated inside the container 11 to the outside of the container 11. Further, the container 11 serves for transmitting light such as sunlight to be absorbed inside the container 11. The container 11 is made of sunlight transmissive materials (for example, glasses). Ideally, the examples of such sunlight transmissive materials include an ultra clear glass having 97% or more of transmittance for sunlight. This ultra clear glass is formed by coating, for example, a glass with a SiO₂ anti-reflection (AR) film with a thickness of 100 nm. Such ultra clear glass may be produced by coating a substance in which, for example, a nano-sized SiO₂ powder is dissolved into a solvent, on the surface of a glass, followed by burning the glass at about 700° C. Further, the glass used for such container 11 may have a concavo-convex shaped (pear-skin pattern) surface. Further, a white plate glass which has the ratio of iron component lower than a usual window glass and has high transparency may be used. Further, the glass may be subjected to special heat treatment for interior protection. Additionally, examples of a glass material include quartz (natural or synthetic quartz (obtained by synthesizing high-pure silicon chloride from silicon dioxide in an additional special chemical process)).

It is preferable that the entire shape of the container 11 be considered to efficiency of the internal light absorption (optical confinement efficiency). For example, as shown in FIG. 2A, the entire shape of the container 11 is a cylindrical shape extending along the uniaxial direction. That is to say, as shown in FIG. 2B, the cross-sectional shape of the container 11 is a circle shape. However, the shape of the container 11 may be other shapes if only a desirable efficiency of light absorption can be kept, and thus, for example, the cross-sectional shape may be a polygonal shape such as rectangle.

The reflector 11a is arranged on a part of the lateral face (rear face being opposite to the light incident face) of the container 11. In the reflector 11a, a plurality of convex sections 11a1 are arranged side by side along the lateral face of the container 11, and the convex sections 11a1 are made of a transmissive material such as BK7 or a quart. The convex section 11a1 has a cylindrical shape or a semi-cylindrical (plano-convex) shape and extends along the same direction as the container 11. That is to say, as shown in FIG. 2B, the cross-sectional shape of the convex section 11a1 is semicircular or ellipsoidal. The number of the convex section 11a1 is preferably, but not limited to, arranged to absorb sunlight in a wider angle range. For example, the number of the convex section 11a1 is preferably set so that the reflector 11a does not block the light passing from the direction of an azimuth angle of 100° toward the container 11 before the light enters the container 11 (so that the light enters the container 11 without contacting the reflector 11a). Further, it is preferable that the reflector 11a is arranged though a given gap (air gap) on the lateral face of the container 11 and thus does not adhere completely to the container 11. The above shape and arrangement of the reflector cause efficient diffused reflection of light in the inside of the container 11 and thus improve light absorption efficiency in the semiconductor chip 12.

On the upside of the container 11, a gas separation filter 13 to separate the gases internally generated, herein hydrogen (H₂) gas and oxygen (O₂) gas is fitted. In the separated hydrogen and oxygen gases by the gas separation filter 13, hydrogen gas may be emitted from a hydrogen gas outlet 13a and oxygen gas may be emitted from a oxygen gas outlet 13b.

Inside the container 11, a plurality of (herein three) pipe arrangements 31 is arranged at a predetermined position, and the pipe arrangement 31 is adapted to have flowing heat exchange fluid B therein. The pipe arrangement 31 is connected to the water heater 30, and thus the heat exchange fluid B is circulated between the water heater 30 and the container 11. A part of the pipe arrangement 31 arranged inside the container 11 (a cooling pipe 31a) is adapted to cool inside the container 11 and concurrently absorb heat in the container 11. Note that the heat exchange fluid B corresponds to a specific example of a heat exchange medium, and the heat exchange medium is not only liquid but aeriform (gaseous) or solid as long as the medium is able to be circulated within the pipe arrangement 31.

The refractive index of the materials used for the pipe arrangement 31 is preferably nearly equal to the refractive index of the electrolytic solution A (for example, within ±0.05) for preventing light from being cut off. Further preferably, the cooling pipe 31a of the pipe arrangement 31 is non-uniformly arranged in a particular region in the container 11. The above constitution facilitates the convection of the electrolytic solution A as a part of the container 11 is cooled and thereby thermal gradient is created within the container 11. Accordingly, this convection stirs the semiconductor chips 12, and therefore an advantage that the precipitation of the semiconductor chips 12 is prevented is provided.

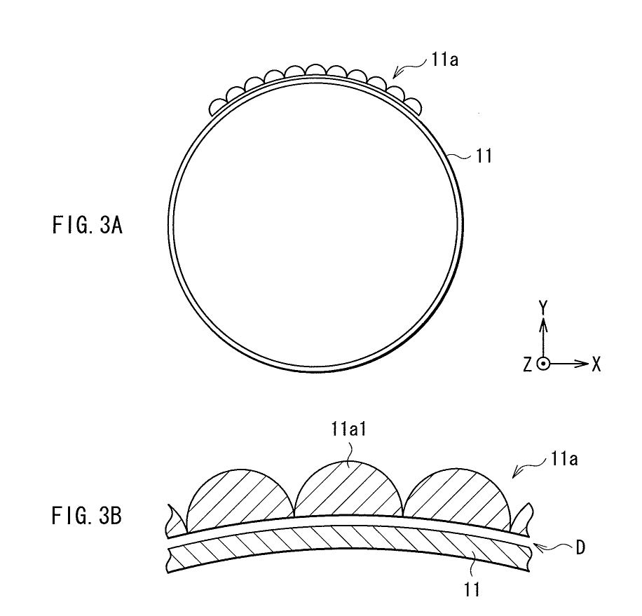

FIGS. 3A and 3B show a simulation result for a suitable shape (exemplary shape) of the above container 11. FIG. 3A is a cross-sectional view of the above container 11, and FIG. 3B is a cross-sectional view enlarging a boundary portion between the lateral face of the container 11 and the reflector 11a. In this simulation, a glass having a refractive index of 1.466 was used as a material for the container 11 and the reflector 11a. In the simulation result, the appropriate shape of the container 11 had an outside diameter of 860 mm, a height (outer size) of 1030 mm, an inside diameter of 834 mm, and a height (inner size) of 1000 mm. Further, as the appropriate shape of the reflector 11a, that is, as the appropriate shape of each of the convex sections 11a1, the cross-sectional surface thereof had a semicircular shape having a diameter of 60 mm and a height of 1030 mm. An appropriate number of such convex section 11a1 was eleven. Further, it was preferable that an air gap was provided between the lateral face of the container 11 and the reflector 11a, and an appropriate size of the air gap D was 4 mm.

The above shape(s) of the container 11 (and the reflector 11a) provides the effective (calculated maximum efficiency) absorption of illuminating light from sun positioned, for example in a range of azimuth angle at the time the midsummer sun moves in a horizontal direction (between −100° and 100°) and in a range of a given elevation angle (between 15° and 90°) into the container 11. Further, for example, the midwinter sun is positioned at low elevation angle (30° or less), and the illuminating light at such angle is also capable of being effectively absorbed.

Semiconductor Chip 12

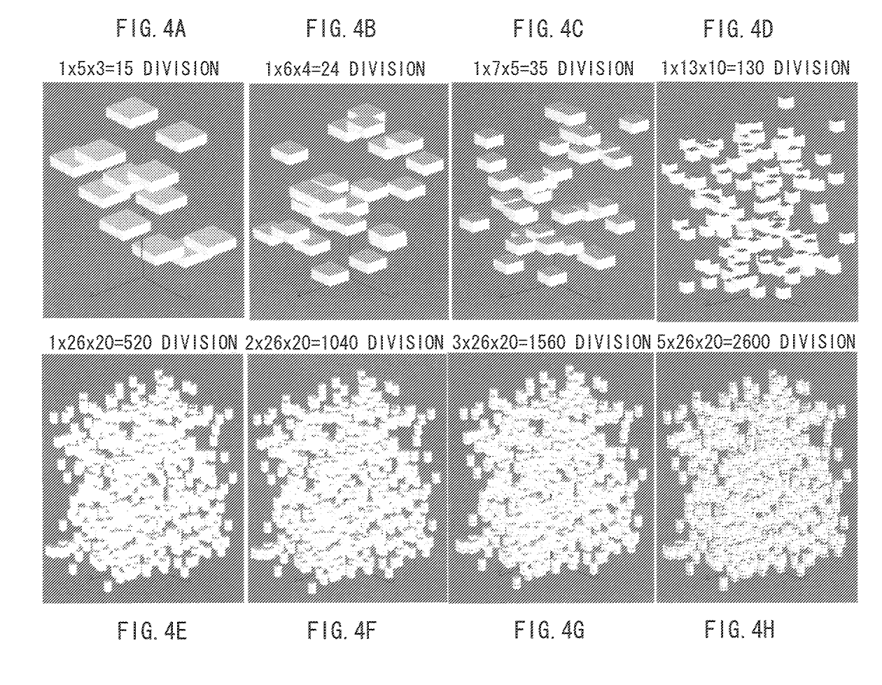

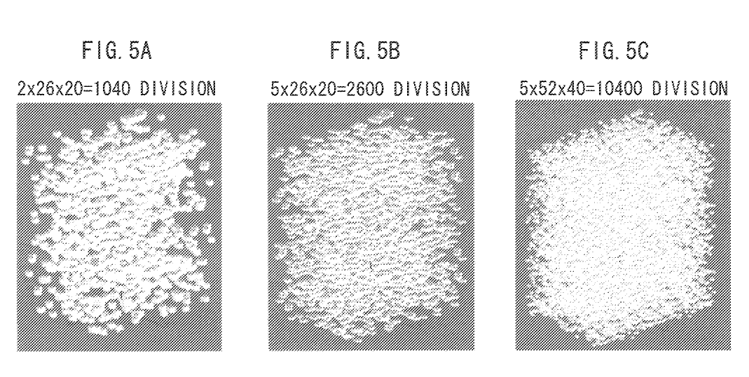

The semiconductor chip 12 is configured of semiconductor materials having a photoelectric conversion function, such as microcrystalline silicon, amorphous silicon, CIGS materials, or GaInP materials. Herein, pn junction devices with a lamination structure (tandem structure) including p-type silicon (for example, boron (B) dopant) and n-type silicon (for example, arsenic (As) dopant) will be described as an example. In addition to the lamination structure, a PIN multiquantum structure may be included therein. The semiconductor chip 12 is produced by multiple dividing a semiconductor wafer. The number of times of division and the size thereof are not limited, and when a semiconductor wafer with the size of, for example, 60 mm (Z)×620 mm (X)×800 mm (Y) is used, the number of times of division may be set as shown in, for example, FIGS. 4A to 4H. FIGS. 4A to 4E show division examples in no longitudinal direction (in Z-direction) but in a lateral direction (in XY plane direction), and FIGS. 4F to 4H respectively show division examples obtained by dividing the divided semiconductor chip shown in FIG. 4E along Z-direction further twice, three times, or five times. Alternatively, the divided semiconductor chip shown in FIG. 4E may be further randomly divided along Z-direction (twice, three times, or five times) as shown in FIGS. 5A to 5C.

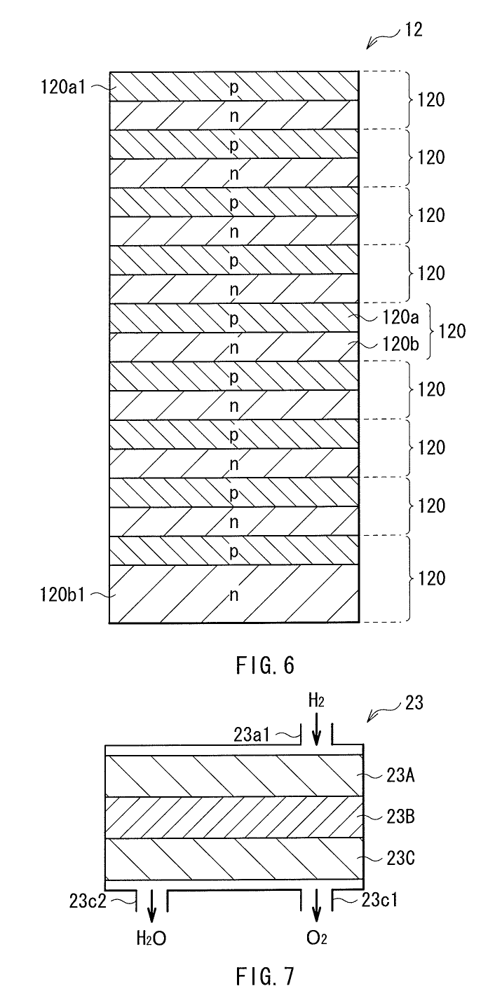

The semiconductor chip 12 specifically has a tandem structure as follow. FIG. 6 shows a cross-sectional structure of the semiconductor chip 12. As shown in FIG. 6, the semiconductor chip 12 is configured by laminating a plurality of (herein, nine) pn junctions 120 each including a p-type Si layer 120a and an n-type Si layer 120b. In other words, the p-type Si layer 120a and the n-type Si layer 120b are alternately laminated by each nine layers. The thickness of the p-type Si layer 120a and the n-type Si layer 120b are respectively, for example, 1 μm. However, the bottom layer of the n-type Si layer 120b1 serves as a buffer layer in wafer formation, and thus is e.g. a 2 μm low dopant layer. In contrast, the top layer of the p-type Si layer 120a1 serves as a cap layer, and thus is a high dopant layer. Additionally, but not shown, such lamination structure has an n-type silicon substrate arranged in the underlayer and a dot electrode by lamination of Au and Ti (for example, diameter: 2 μm, pitch: 5 μm) arranged on the upper layer.

It is preferable to previously calculate an electric voltage needed for the electric double layer and an electric voltage needed for electrolysis of water and subsequently to set the number of laminations of the semiconductor chip 12 (the number of the pn junction 120) so as to generate the electromotive force with electric voltage higher than the total electric voltage of the two. In the embodiment, when p-type silicon and n-type silicon for the semiconductor chip 12 and 5% phosphoric acid solution as an electrolytic solution A are used, it is recognized that the above total electric voltage is obtained in the lamination structure having nine p- and n-type Si layers.

The semiconductor chip 12 may be produced, for example, in the following way. First, an n-type silicon substrate is subjected to film formation for forming a low doped n-type Si layer 120b1 as a buffer layer having a film thickness of 2 μm, and subsequently forming the p-type Si layer 120a having a film thickness of 1 μm, and a n-type Si layer 120b having a film thickness of 1 μm. In the film formation, both of films of the p-type Si layer 120a and the n-type Si layer 120b may be formed by, for example, the CVD method. The total nine pairs of laminated films are formed with a pair of the p-type Si layer 120a and the n-type Si layer. Note that the p-type Si layer 120a1 finally formed is a high doped layer. On the wafer surface formed in the above way (on the p-type Si layer 120a1), a dot electrode laminated in order of gold (Au), titanium (Ti), and gold is formed by using, for example, a vacuum deposition method or a photolithographic method.

The produced wafer in the above way is finely cut (divided) into a die-shaped chip with size of a few millimeters by singulating into desirable sized pieces. The lateral face of the lamination film exposed by the singulating is coated by a thermal oxidation treatment. This coating inhibits the photocatalytic degradation, caused by the contact with the electrolytic solution A, of the lateral surface portion of the laminate film. Further, when crystal defects are caused on the lateral surface, this coating prevents a dark current from leaking through the crystal defects. Further, the coating serves for insulating between a positive electrode and a negative electrode in the semiconductor chip 12. As described above, a plurality of semiconductor chips 12 having a multilayer structure with the p-type Si layer 120a and the n-type Si layer 120b may be produced.

Note that the method for producing the semiconductor chip 12 is not limited to the above method. Therefore, a semiconductor wafer may be divided after a plurality of laminated films on the substrate is processed to have a column-shape (totally-concavo-convex shape) with lithography and etching.

Power Generation Section 20

The power generation section 20 has, for example, a hydrogen bomb 21, an oxygen bomb 22, and a fuel cell 23. The hydrogen bomb 21, serving for storing hydrogen gas, contains hydrogen separated by the gas separation filter 13 (discharged from the hydrogen gas outlet 13a shown in FIG. 2A) and further supplies the separated hydrogen to the fuel cell 23. The oxygen bomb 22, serving for storing oxygen gas, contains oxygen separated by the gas separation filter 13 (discharged from the oxygen gas outlet 13b shown in FIG. 2A) and further supplies the separated oxygen to the fuel cell 23. The fuel cell 23 serves for generating electrical energy by chemically reacting hydrogen with oxygen.

FIG. 7 shows a structure example of the fuel cell 23. As shown in FIG. 7, the fuel cell 23 is configured to sandwich an electrolytic layer 23B between an anode electrode 23A and a cathode electrode 23C. On the anode electrode 23A side, a hydrogen supply port 23a1 through which hydrogen from the hydrogen bomb 21 is introduced is provided. On the cathode electrode 23C side, an oxygen supply port 23c1 through which oxygen from the oxygen bomb 22 is introduced is provided. Further on the cathode electrode 23C side, a discharge port through which water (H₂O) as a reaction product is discharged is provided.

Water Heater 30

The water heater 30 has a function of absorbing (recovering) heat energy generated inside the container 11, and thus such function allows the supply of, for example, heated water C. The water heater 30, having a heat exchanger 30a connected with the pipe arrangement 31, serves for recovering absorbed heat energy of the heat exchange fluid B in the pipe arrangement 31 to circulate the heat exchange fluid B after energy recovering by returning again to the pipe arrangement 31. Therefore, in passing through the cooling pipe 31a, the heat exchange fluid B circulating through the pipe arrangement 31 absorbs heat energy during cooling within the pipe arrangement 31, and subsequently flows into a first end e1 of the heat exchanger 30a through the pipe arrangement 31. Next, in the heat exchanger 30a, the heat exchange fluid B flows out of a second end e2 of the heat exchanger 30a toward the pipe arrangement 31 again after recovering the heat energy absorbed by the heat exchange fluid B. In this way, heat energy inside the container 11 is absorbed by the water heater 30.

Action and Effect of Power Generation System 1

Electrical Energy Generation

In the embodiment, the light absorbed inside the container 11 is diffusely reflected by the reflector 11a, and subsequently is absorbed into the plurality of semiconductor chips 12 in the gas generation section 10. In the semiconductor chip 12, a plurality (in this case, nine layers) of pn junctions 120 including a p-type Si layer 120a and a n-type Si layer 120b is laminated, and thus sufficient electromotive force is generated. For example, when nine pn junctions 120 according to the embodiment are laminated in series, the electromotive force equivalent to 4.5 V may be generated. Consequently, gases (hydrogen and oxygen) are dramatically generated as bubbles in the container 11 (conversion of light energy into gases), and thus the generated gases are separated into hydrogen and oxygen through the gas separation filter 13.

The separated hydrogen is stored in the hydrogen bomb 21 of the power generation section 20, and the separated oxygen is stored in the oxygen bomb 22, respectively. In the power generation section 20, electrical energy is generated by utilizing hydrogen and oxygen respectively stored in the hydrogen bomb 21 and the oxygen bomb 22 in the above way. Specifically, in the fuel cell 23, as hydrogen is supplied to the anode electrode 23A side shown in FIG. 7, the reaction of a reaction formula (1) occurs in the anode electrode 23A. On the other hand, as oxygen is supplied to the cathode electrode 23C side, the reaction of the following reaction formula (2) occurs in the cathode electrode 23C. Electrical energy is generated by such electrochemical reaction (chemical energy is converted into electrical energy). Additionally, water generated in the cathode electrode 23C is discharged outside through the discharge port 23c2.

H₂→2H⁺2e⁻ (1)

(½)O₂+2H⁺+2e⁻→3H₂O (2)

Obtainment of Heat Energy

In contrast, the temperature increase is caused by the heat of reaction resulted from the above electrolysis and the radiant heat from sunlight in the container 11. In the embodiment, the pipe arrangement 31, which connects the container 11 with the water heater 30, has a portion (container 11 side) arranged inside the container 11 as a cooling pipe 31a, and equally another portion connected to a given heat exchanger 30a in the water heater 30. In circulating heat exchange fluid B inside such pipe arrangement 31, the heat exchange fluid B passes through the cooling pipe 31a to absorb heat energy during cooling inside the container 11, followed by flowing into the first end e1 of the heat exchanger 30a through the pipe arrangement 31. Subsequently, the heat exchange fluid B flows out of the second end e2 of the heat exchanger 30a after recovering the heat energy absorbed by the heat exchange fluid B. In this way, the heat energy inside the container 11 is absorbed by circulating the heat exchange fluid B in water heater 30.

As described above, the gas generation section 10 according to the embodiment, in which the electrolytic solution A and the plurality of semiconductor chips 12 with photoelectric conversion function are enclosed in the container 11, allows the plurality of semiconductor chips 12 to absorb incident light into the container 11, and therefore the electrolysis reaction occurs in the electrolytic solution A. Accordingly, gases (hydrogen and oxygen) are generated inside the container 11, and the power generation section 20 is enabled to generate electrical energy utilizing the generated gases. Meanwhile, although the temperature increase is caused by the heat of reaction resulted from the above electrolysis and the radiant heat from sunlight in the container 11, the water heater 30 may absorb heat energy from inside the container 11. Consequently, it is enabled to obtain both of electrical energy and heat energy by utilizing light energy.

In other words, it is enabled to utilize light energy from the sun as not only electrical energy but also heat energy, and thus the full utilization of light energy may be achieved. The achievement of such system promises various applications as a hybrid power generation system.

Further, the arrangement of the cooling pipe 31a inside the container 11 (preferably, in the rear side, i.e. opposite side to light incident side of the container 11) allows not only absorption of heat energy within the container 11 in the above way but also the generation of temperature gradient inside the container 11 for causing heat convection. Note that although the plurality of semiconductor chips 12 enclosed in the container 11 sometimes settle down onto the bottom of the container 11, the settling semiconductor chips 12 hardly develop electromotive force due to reduction of light utilization efficiency. As the above heat convection is caused in the container 11, the electrolytic solution A is stirred and further, the semiconductor chips 12 are uniformly dispersed, and consequently, light utilization efficiency easily improves.

Further, the above absorption of heat energy promises the following effects. That is, it is possible to cool the solar battery element using pn junction in which, as is known, the conversion efficiency reduces due to temperature increase.

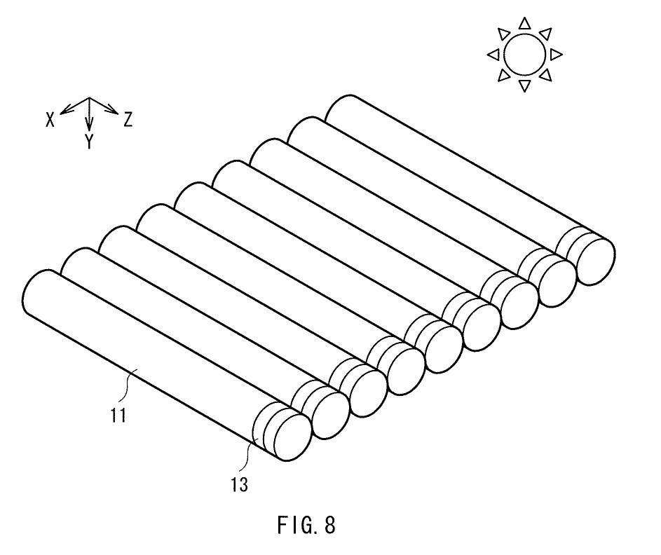

Further, in the gas generation section 10, since the container 11 has a given cylindrical shape and further includes a given reflector 11a, it becomes easy to absorb incident light (incident angle range for absorbing incident light is wide). Consequently, the container 11 may be freely installed. For example, the container 11 is usable in a standing position, and thus may be arranged in a small space such as a balcony. In particular, it is usable to install such container 11 in a standard home. Of course, on the flat surface such as an exterior wall or a roof of a house, a plurality of containers 11 may be arranged side by side in a lying state (FIG. 8).

Additionally, since the container 11 has a given cylindrical shape and further includes a given reflector 11a on a part of the lateral face thereof, it becomes to effectively absorb light, for example, light from the sun positioned at an azimuth angle between −100° and 100° and at an elevation angle between 15° and 90° in the inside of the container 11. In other words, it becomes easy to efficiently absorb sunlight regardless of seasons or hours, compared to an existing plane panel-type solar battery.

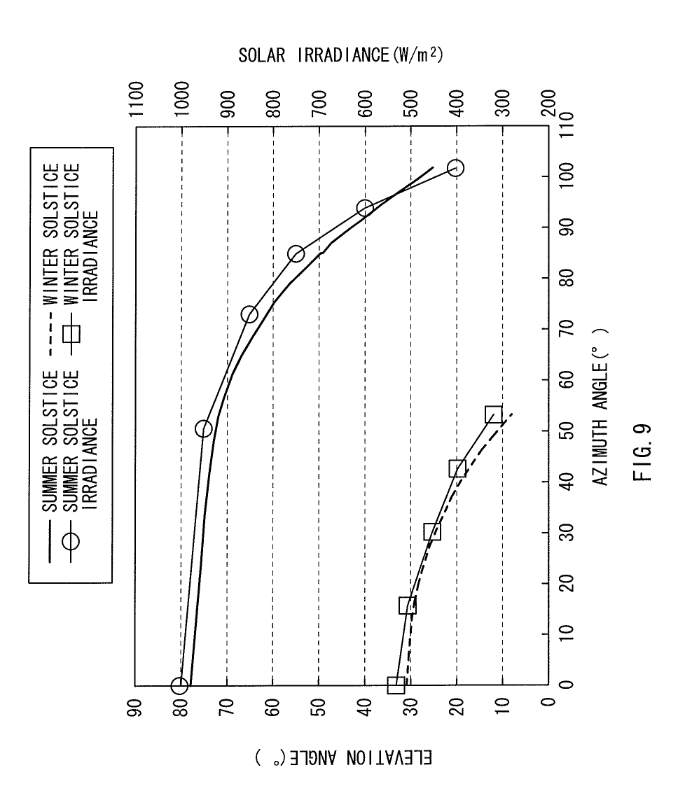

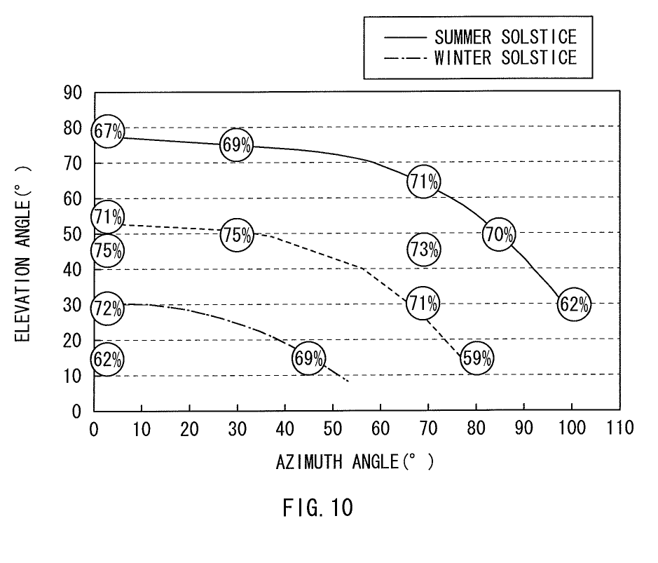

Next, a relation between sun position (azimuth angle, elevation angle) and solar irradiance will be described with a reference to FIG. 9. As shown in FIG. 9, it is understood that, if the sun may be positioned at an azimuth angle between −100° and 100° and at an elevation angle between 15° to 90°, most sunlight may be absorbed without loss. Further, FIG. 10 shows the light absorption efficiency corresponding to sun position.

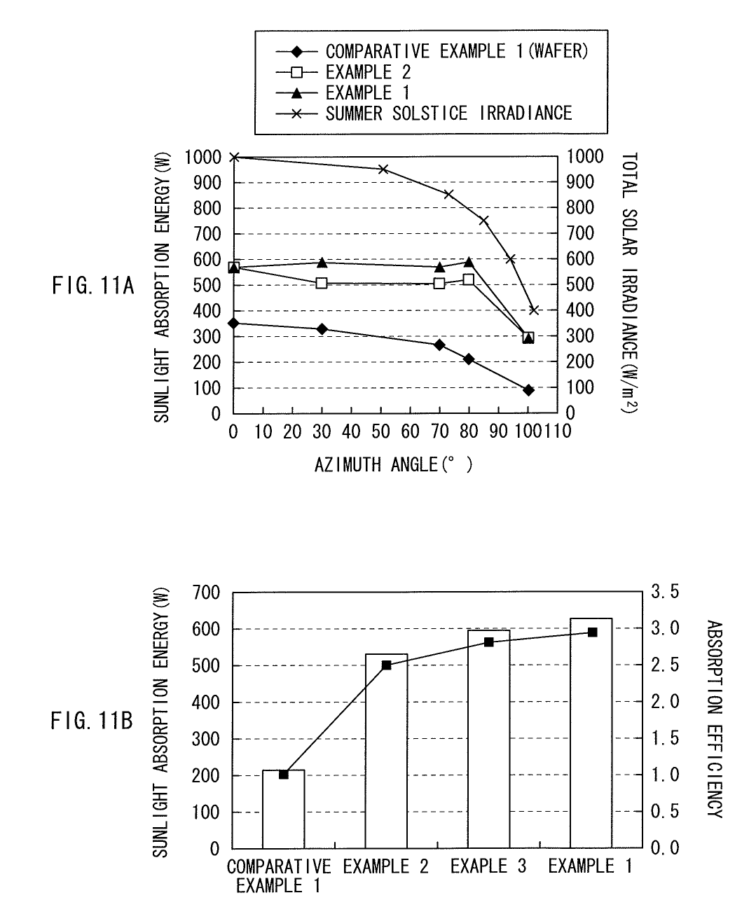

Further, FIG. 11A shows a relation between azimuth angles of the sun and absorption energy. In FIG. 11A, Example 1 shows characteristics in a case that a cylindrical container 11 having the reflector 11a described in the embodiment was used. Additionally, Example 2 shows characteristics in a case that a rectangular parallelepiped (box-shaped) container without a reflector was used. Further, a comparative example shows characteristics in a case that a wafer was used (panel-type solar battery), and total solar irradiances (W/m²) on midsummer are denoted. Note that the total area of the semiconductor chip used in Example 1 or 2 is equivalent to the plane area of the wafer in the comparative example. As a result, it is understood that the absorption energy in Example 1 substantially increases compared to the comparative example being in a wafer form. Further, in FIG. 11B, the sunlight absorption energy (bar chart) and the absorption efficiency of sunlight (line chart) at elevation angle of 45° are denoted for the above comparative example, Examples 1 and 2, and a case of using a container without a reflector (Example 3). As a result, in the absorption energy of the incident light at an elevation angle of 45°, while the value in Example 3 is 595.44 W, the same in Example 1 is 622.47 W. Therefore, the light absorption efficiency may improve by about 4.5% by providing the reflector 11a on the cylindrical container 11. Additionally, the absorption energy in Example 1 improves by 13% or more, further compared to Example 2 with a rectangular parallelepiped box shape. Further, compared to the panel-type comparative example, the absorption energy of Example 1 improves by about 293%.

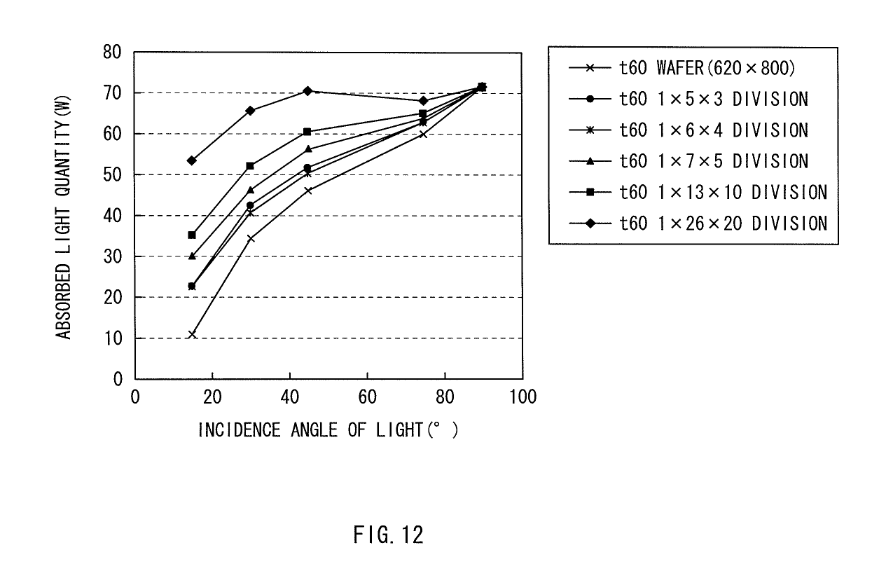

Further, FIG. 12 shows a relation between an incidence angle of light and an absorbed light quantity in each number of times of dividing wafer. This indicates that, as the number of times a wafer is divided increases, an absorbed light quantity is hardly dependent on incident angle. It is understood that the more the number of division times, that is, the more the finer semiconductor chips are dispersed, the higher the light absorption efficient.

Next, the modification of the above embodiment will be described. In the description below, components are denoted by the same reference numerals, and thus detailed description thereof will be hereinafter omitted.

Modification

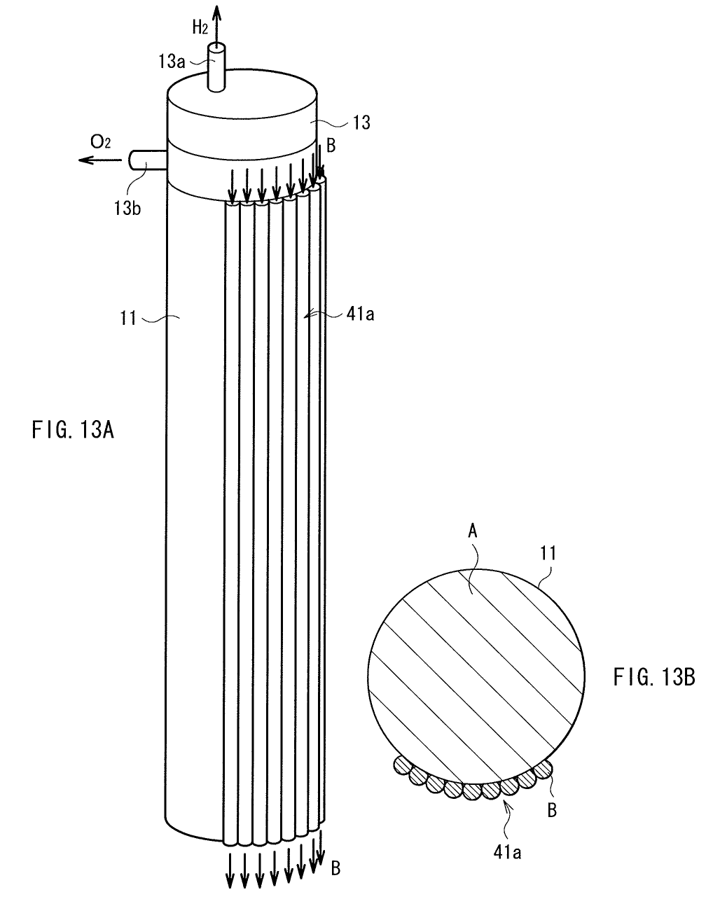

FIGS. 13A and 13B are views illustrating a constitution of a gas generation section according to a modification 1. FIG. 13A is a perspective view, and FIG. 13B is a cross-sectional view. The gas generation section of the modification also may be applied to the power generation system having a gas separation filter 13, a power generation section 20, and a water heater 30 similar to those of the above embodiment. In the modification, the gas generation section is filled with an electrolytic solution A in the container 11, and a plurality of semiconductor chips 12 are dispersed in the electrolytic solution A. Further, the container 11 has a cylindrical shape as a whole, and has a reflector 41a on a part of the lateral face thereof. Further, the reflector 41a is configured by arranging a plurality of convex sections side by side, for example, along the lateral face of the container 11. The convex sections of the reflector 41a are configured of the same materials as the convex sections 11 al of the above embodiment, and the arrangement and number of the convex sections are set from the reason described above. Further, each exterior shape of the convex sections is cylindrical shape, and the outer shape (outline) at a cross-section is semicircular or ellipsoidal as shown in FIG. 13B.

However, in this modification, the reflector 41a is molded into hollow shape, and is adapted that a heat exchange fluid B flows inside the reflector 41a. In other words, the reflector 41a according to the modification functions as a cooling pipe described in the embodiment, and is arranged as a part of the above pipe arrangement 31. In this case, the reflector 41a is different from that of the above embodiment and is preferably closely arranged on the lateral face of the container 11. The construction improves a cooling effect in the container 11 and also facilitates to easily absorb heat energy.

As shown in the modification, the cooling pipe to absorb heat energy may be arranged, but not limited to inside the container 11, adjacent to the lateral face thereof. Therefore, the same effect as the above embodiment may be obtained, and further the reflector 41a may be concurrently used as a cooling pipe. Therefore, compared to the case of arrangement of the cooling pipe in the inside of the container 11, since heat convection in the container 11 is not prevented, effective stirring is achieved inside the container 11.

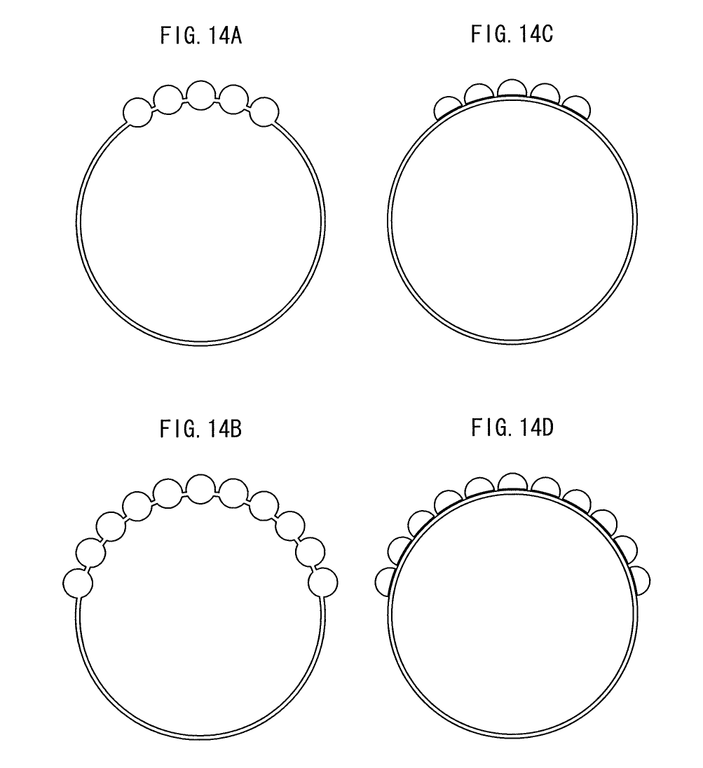

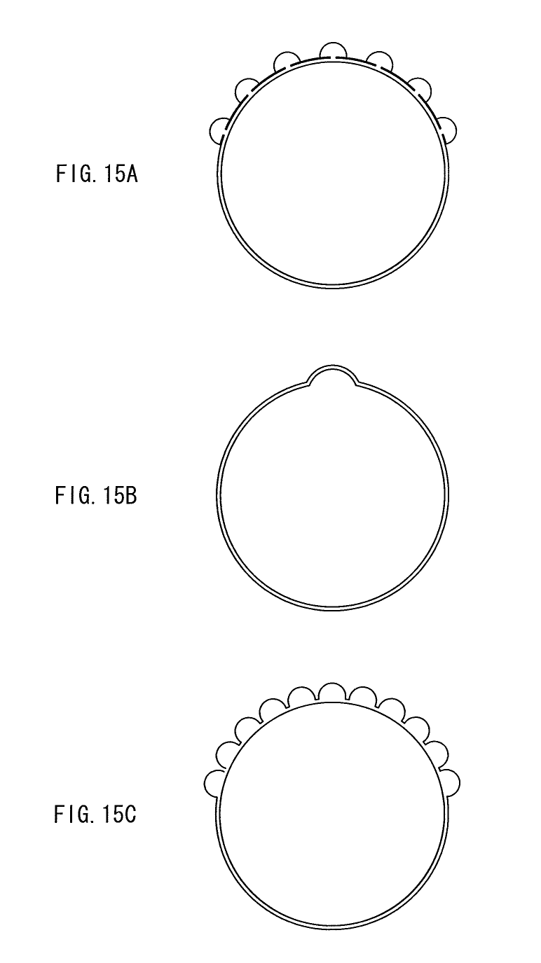

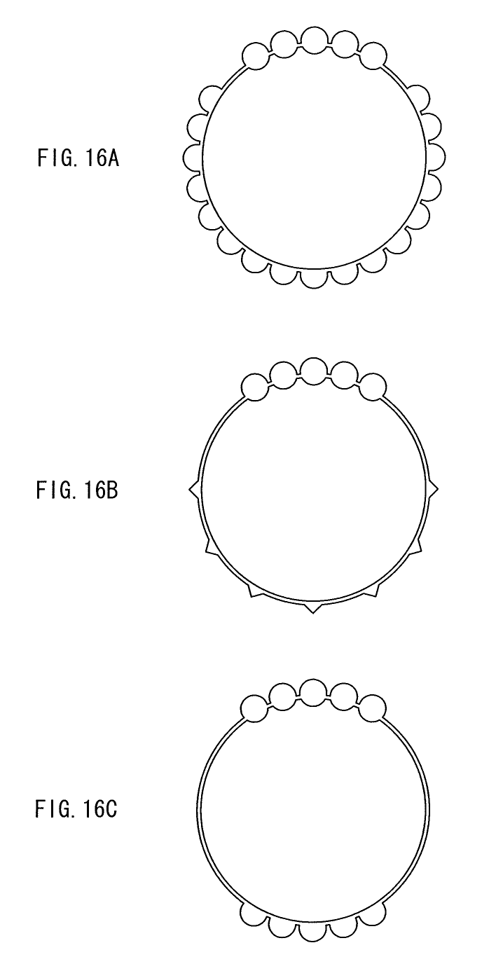

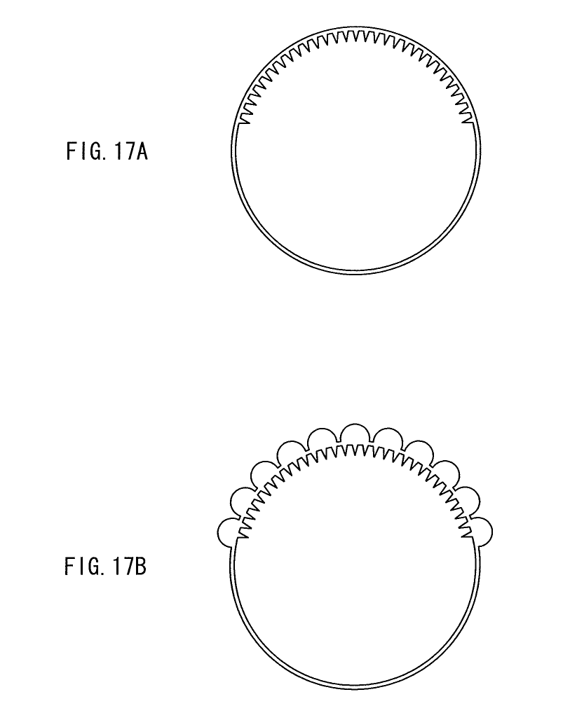

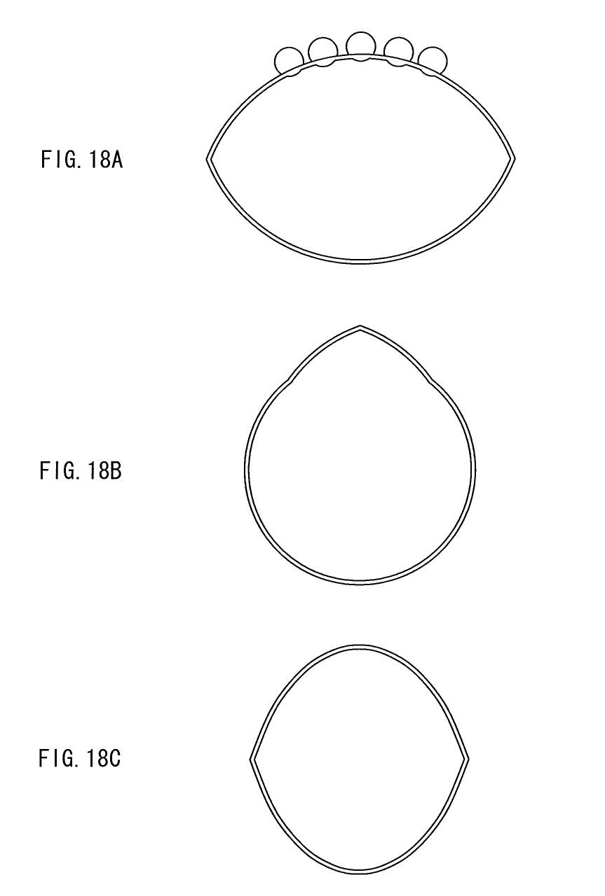

In the above description, although the present disclosure is described using the embodiment and the modification, but not limited to the above embodiment, the present disclosure may be variously modified. For example, examples of suitable shapes of the container 11 and the reflector 11a in the above embodiment include shapes shown in FIGS. 3A and 3B. However, the shapes of the container and the reflector are not limited to this, and may be various shapes. For example, the shapes may be shapes shown in each view, FIGS. 14A to 14D, FIGS. 15A to 15C, FIGS. 16A to 16C, FIGS. 17A and 17B, and FIGS. 18A to 18C.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A power generation system comprising:
a gas generation section including one or more containers and producing gas by absorbing light energy, each of the containers enclosing an electrolytic solution and a plurality of semiconductor elements having photoelectric conversion function;
a power generation section generating electrical energy by utilizing gas generated in the gas generation section; and
a heat exchanger absorbing heat energy from the inside of the container.

2. The power generation system according to claim 1, further comprising a pipe arrangement to circulate a heat exchange medium between the container and the heat exchanger, wherein
a cooling pipe corresponding to a part of the pipe arrangement is arranged inside the container or adjacent to the lateral face of the container.

3. The power generation system according to claim 2, wherein one or more of the cooling pipes are unevenly arranged in a particular region within the container.

4. The power generation system according to claim 3, wherein the cooling pipes are arranged in a region opposite to a light incident side within the container.

5. The power generation system according to claim 2, wherein the container has a reflector, having a hollow structure, arranged adjacent to the lateral face of the container, and
the reflector functions as the cooling pipe.

6. The power generation system according to claim 1, wherein the cross sectional face of the container has a polygon or round shape.

7. The power generation system according to claim 6, wherein the container has a reflector on a part of lateral face of the container.

8. The power generation system according to claim 7, wherein the reflector has an air gap between the lateral face of the container and the reflector.

9. The power generation system according to claim 7, wherein the reflector has a plurality of convex sections.

10. The power generation system according to claim 9, wherein each of the convex sections has a semicircular or oval cross sectional face.

11. The power generation system according to claim 1, wherein the containers are arranged side by side.

12. The power generation system according to claim 1, wherein the semiconductor elements are produced by dividing a semiconductor wafer into a plurality of parts.

13. The power generation system according to claim 12, wherein each of the semiconductor elements is formed by alternately laminating a p-type silicon layer and an n-type silicon layer more than once.

14. The power generation system according to claim 1, wherein the gas contains at least hydrogen (H₂).

15. The power generation system according to claim 14, wherein the gas contains the hydrogen (H₂) and oxygen (O₂).

16. The power generation system according to claim 15, further comprising a gas separation filter separating hydrogen and oxygen generated by the gas generation section.

17. The power generation system according to claim 16, wherein the power generation section includes:
gas storage sections storing each gas of hydrogen and oxygen separated by the gas separation filter, and
a fuel cell generating electrical energy by utilizing hydrogen and oxygen stored in the gas storage sections.
